(19) United States
(12) Patent Application Publication
(10) Pub. No.: US 2026/0254981 A1
(43) Pub. Date: Aug. 27, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih Esenlik, Los Angeles, CA (US); Yaojun Wu, Beijing (CN); Zhaobin Zhang, Los Angeles, CA (US); Meng Wang, Hong Kong (CN); Kai Zhang, Los Angeles, CA (US); Li Zhang, Los Angeles, CA (US)

(21) Appl. No.: 19/651,539

(22) Filed: Apr. 17, 2026

Related U.S. Application Data
(63) Continuation of application No. PCT/CN2024/125947, filed on Oct. 18, 2024.

(30) Foreign Application Priority Data
Oct. 19, 2023 (WO) PCT/CN2023/125447

(51) Int. Cl. H04N 19/42; H04N 19/132; H04N 19/184

(52) U.S. Cl. CPC H04N 19/42; H04N 19/132; H04N 19/184

(57) ABSTRACT

A solution for visual data processing is provided. A method for visual data processing is proposed. The method comprises: performing a conversion between visual data and a bitstream of the visual data with a neural network (NN)-based model, a pooling layer in the NN-based model being configured to be applied with a padding operation that is used for padding at least one sample for an input tensor of the pooling layer.

### CROSS REFERENCE TO RELATED APPLICATIONS

This application is a continuation of International Application No. PCT/CN2024/125947, filed on Oct. 18, 2024, which claims the benefit of International Application No. PCT/CN2023/125447, filed on Oct. 19, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: performing a conversion between visual data and a bitstream of the visual data with a neural network (NN)-based model, a pooling layer in the NN-based model being configured to be applied with a padding operation that is used for padding at least one sample for an input tensor of the pooling layer.

Based on the method in accordance with the first aspect of the present disclosure, a pooling layer in the NN-based model is configured to be applied with a padding operation that is used for padding at least one sample for an input tensor of the pooling layer. Compared with the conventional solution where a pooling layer does not include any padding operation, the proposed method can advantageously support various possible sizes of the input tensor of the pooling layer. Thereby, the coding flexibility and coding efficiency can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: performing a conversion between the visual data and the bitstream with a neural network (NN)-based model, a pooling layer in the NN-based model being configured to be applied with a padding operation that is used for padding at least one sample for an input tensor of the pooling layer.

In a fifth aspect, a method for storing a bitstream of visual data is proposed. The method comprises: performing a conversion between the visual data and the bitstream with a neural network (NN)-based model, a pooling layer in the NN-based model being configured to be applied with a padding operation that is used for padding at least one sample for an input tensor of the pooling layer; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to some embodiments of the present disclosure;

FIG. 8 illustrates an example learning-based image codec architecture;

FIG. 9 illustrates an example synthesis transform for learning based image coding;

FIG. 10 illustrates an example LeakyReLU activation function;

FIG. 11 illustrates an example ReLU activation function;

FIG. 12 illustrates an example latent combine block;

FIG. 13 illustrates an example latent combine block;

FIG. 14 illustrates a flowchart of a method for visual data processing in accordance with embodiments of the present disclosure; and

FIG. 15 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment.

Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

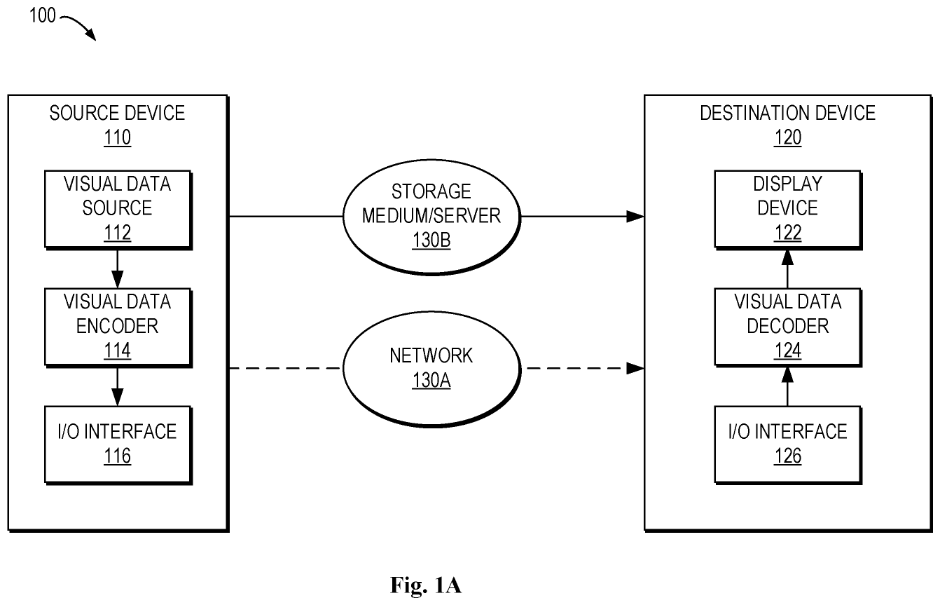

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter.

The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Brief Summary

The present disclosure is related to neural network (NN)-based image and video coding. Specifically, it is related to modification convolution, activation and pooling layers. The modifications target making the layers suitable for implementation in different device types. The ideas may be applied individually or in various combinations, for image and/or video coding methods and specifications.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG.

With the performance of neural image compression continually being improved, neural network-based video compression has become an actively developing research area. However, neural network-based video coding still remains in its infancy due to the inherent difficulty of the problem.

### 2.1 Image/Video Compression

Image/video compression (also referred to as image/video coding) usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime.

Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility.

Nevertheless, this technology is still far from mature and a lot of challenges need to be addressed.

### 2.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate−log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit−log₂ p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁.

Most of the methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks. FIG. 1B illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1B, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and R, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 2.3.3 Hyper Prior Model

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

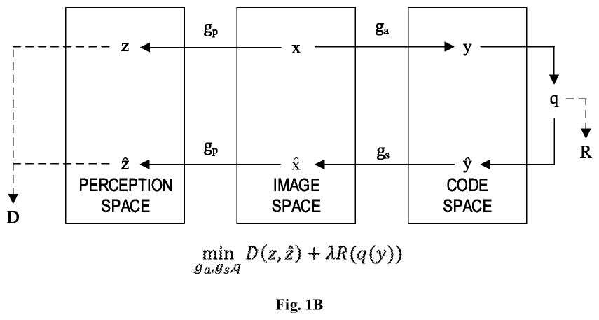

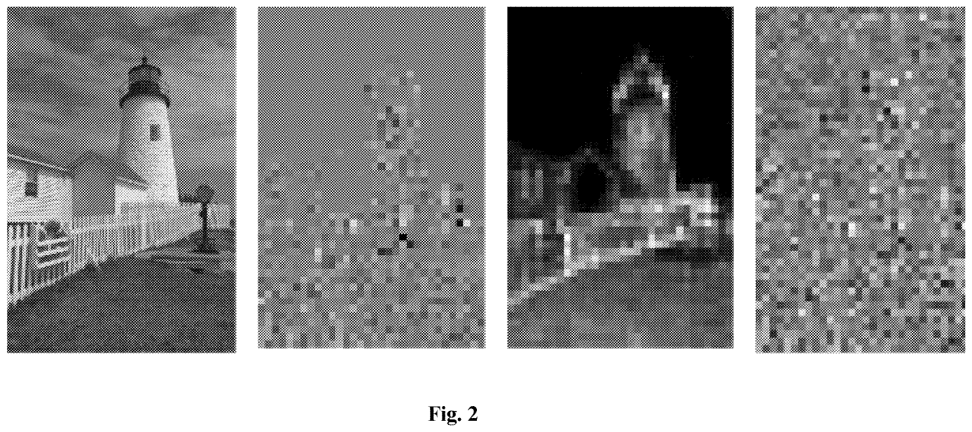

As evident from the middle left and middle right image of FIG. 2, there are significant spatial dependencies among the elements of ŷ. Notably, their scales (middle right image) appear to be coupled spatially. In an existing design, an additional set of random variables \hat{z} are introduced to capture the spatial dependencies and to further reduce the redundancies. In this case the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.

In FIG. 2: Left: an image from the Kodak dataset. Middle left: visualization of the latent representation y of that image. Middle right: standard deviations σ of the latent. Right: latents y after the hyper prior (hyper encoder and decoder) network is introduced.

FIG. 3 illustrates a network architecture of a autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitsteam and transmitted to the receiver (decoder) along with ŷ.

### 2.3.4 Context Model

Although the hyper prior model improves the modelling of the probability distribution of the quantized latent ŷ, additional improvement can be obtained by utilizing an autoregressive model that predicts quantized latents from their causal context (Context Model).

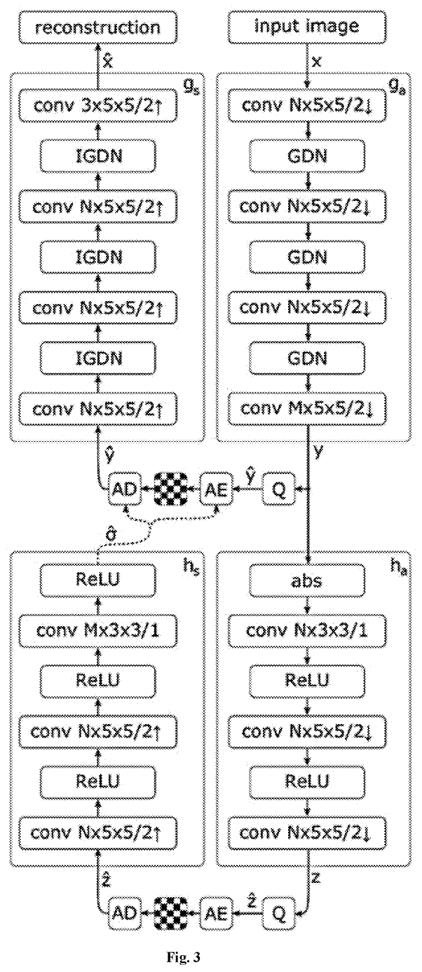

The term auto-regressive means that the output of a process is later used as input to it. For example the context model subnetwork generates one sample of a latent, which is later used as input to obtain the next sample. FIG. 4 is a schematic diagram illustrating an example combined model configured to jointly optimize a context model along with a hyperprior and the autoencoder. The following Table 1 illustrates meaning of different symbols.

TABLE 1
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ(y; θₕₑ) |
| Hyper-Latents | z |
| Hyper-Latents (quantized) | \hat{z} |
| Hyper Decoder | gₕ(\hat{z}; θ_{hd}) |
| Context Model | g_{cm}(y_{<i}; θ_{cm}) |
| Entropy Parameters | gₑₚ(•; θₑₚ) |
| Reconstruction | \hat{x} |

A joint architecture where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 4 illustrates the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically the latent samples are modeled as gaussian distribution or gaussian mixture models (not limited to). In an existing design and according to the FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as p and a).

### 2.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w} where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

where ⊙ is channel-wise multiplication, i.e., yₛ(i)=y(i)×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as

$${y}_{s}^{′} = \hat{y} ⊙ {m}_{s}^{′}$$

where y is the decoded quantized latent representation and y′ₛ is the inversely gained quantized latent representation, which will be fed into the synthesis network.

To achieve continuous variable rate adjustment, interpolation is used between vectors. Given two pairs of gain vectors {mₜ, m′ₜ} and {mᵣ, m′ᵣ}, the interpolated gain vector can be obtained via the following equations.

$${m}_{v} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since 1 is a real number, an arbitrary bit rate between the given two gain vector pairs can be achieved.

### 2.3.6 the Encoding Process Using Joint Auto-Regressive Hyper Prior Model

The FIG. 4 corresponds to the state of the art compression method that is proposed. In this section and the next, the encoding and decoding processes will be described separately.

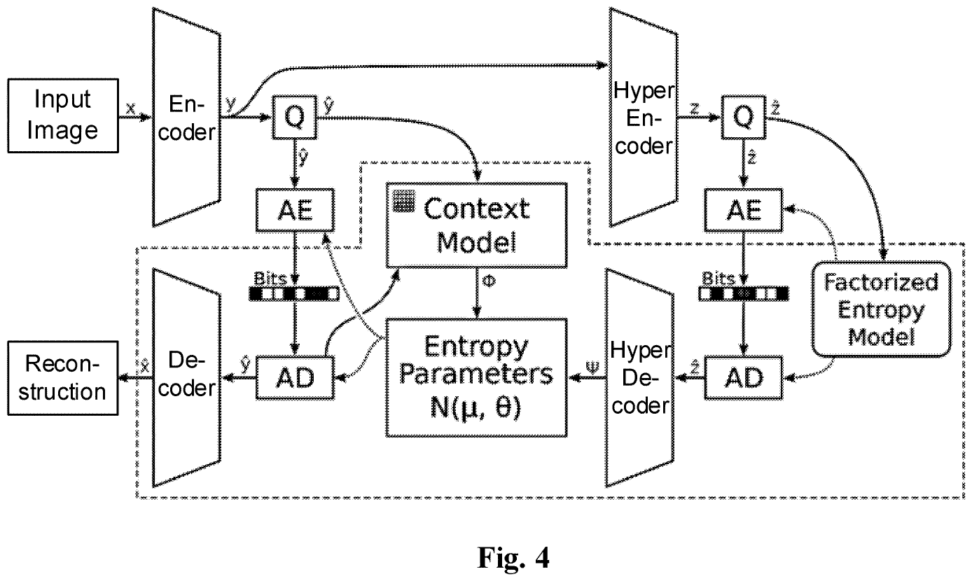

The FIG. 5 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i, j, k] or ŷ[ij] depending on the dimensions of the matrix ŷ. The samples ŷ[ij] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[ij], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above.

In the above description, the all of the elements in FIG. 5 are collectively called encoder. The analysis transform that converts the input image into latent representation is also called an encoder (or auto-encoder).

### 2.3.7 the Decoding Process Using Joint Auto-Regressive Hyper Prior Model

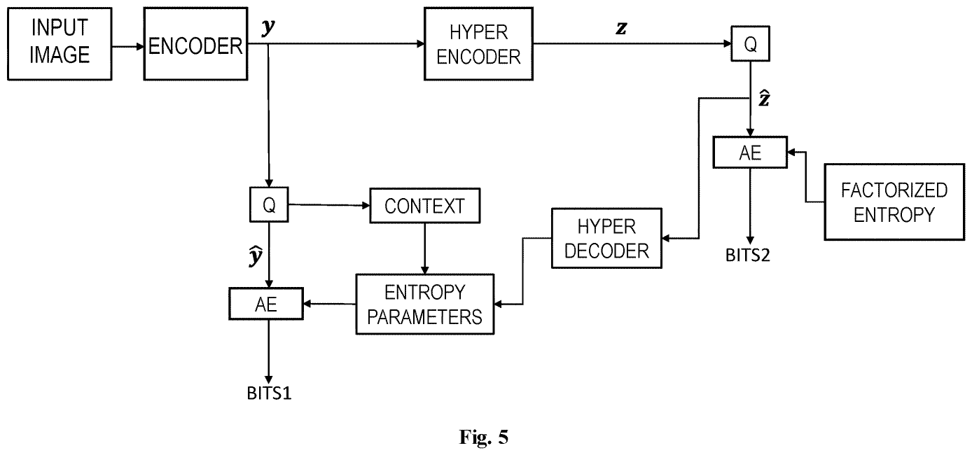

The FIG. 6 depicts the decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module.

The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent y is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$M S E = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 2.6 Separate Processing of Luma and Chroma Components of an Image

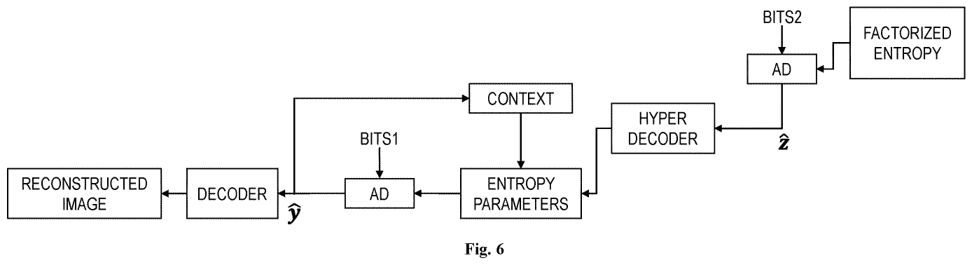

FIG. 7 illustrates the decoding process according to some embodiments of the present disclosure.

According to one implementation, the luma and chroma components of an image can be decoded using separate subnetworks. In FIG. 7, the luma component of the image is processed by the subnetworks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of the above separate processing is that the computational complexity of the processing of an image is reduced by application of separate processing. Typically in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically the separate processing of luma and chroma components of an image does not result in a prohibitive reduction in performance, as the correlation between the luma and chroma components are typically very small.

The processing (Decoding process) in the above figure can be explained below:
1. Firstly, the factorized entropy model is used to decode the quantized latents for luma and chroma, i.e., \hat{z} and \hat{z}ᵤᵥ in FIG. 7.
2. The probability parameters (e.g. variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural-network based postprocessing module. The present disclosure is not limited to the UCCI subnetwork, any other neural network based postprocessing module might also be used.

An exemplary implementation of the present disclosure is depicted in the FIG. 7 (the decoding process). The framework comprises two branches for luma and chroma components respectively. In each of the branch, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and \hat{z}ᵤᵥ.

After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of aprediction module using the samples ŷ[:, m, n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:, i, j].
4. The mean value mean[:, i, j] and the quantized residual latent Q[:, i, j] are added together to obtain the latent y[:, i, j].
5. The steps 1-4 are repeated for the next sample.

Whether to and/or how to apply at least one method disclosed in the document may be signaled from the encoder to the decoder, e.g. in the bitstream.

Alternatively, whether to and/or how to apply at least one method disclosed in the document may be determined by the decoder based on coding information, such as dimensions, color format, etc.

Alternative or additionally, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in the FIG. 7 might be an entropy decoding module. It might be a range decoder or an arithmetic decoder or the like.

The proposed solution described herein is not limited to the specific combination of the units exemplified in FIG. 7. Some of the modules might be missing and some of the modules might be displaced in processing order. Also additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the proposed solution is not affected by the removing of one or more of the said scaling and adding modules.

In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

In one example the primary and secondary color components of an image are coded separately, using networks with similar architecture, but different number of channels as shown in 8. All boxes with same names are sub-networks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding.

Vertical arrows show data exchange between primary and secondary components pipelines.

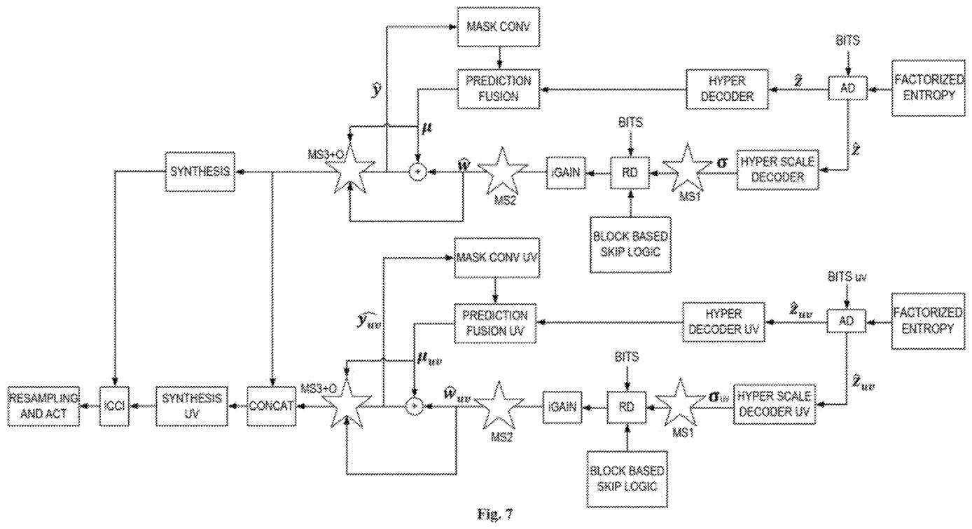

The input signal to be encoded is notated as x, latent space tensor in bottleneck of variational auto-encoder is γ. Subscript “Y” indicates primary component, subscript “UV” is used for concatenated secondary components, there are chroma components. FIG. 8 illustrates learning-based image codec architecture.

First the input image that has RGB color format is converted to primary (Y) and secondary components(UV). The primary component x_{γ} is coded independently from secondary components x_{UV} and the coded picture size is equal to input/decoded picture size. The secondary components are coded conditionally, using x_{γ} as auxiliary information from primary component for encoding x_{UV} and using ŷγ as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{γ}, x_{UV} goes through a module which adjusts the sample location by down-sampling (marked as “s↓” on FIG. 8), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s↑” on FIG. 8), which outputs secondary components up-sampled with factor s.

The example in FIG. 8 exemplifies an image coding system, where the input image is first transformed into primary (Y) and secondary components (UV). The outputs \hat{x}_{γ}, x_{UV} are the reconstructed outputs corresponding to the primary and secondary components. At the and of the processing, x_{γ}, x_{UV} are converted back to RGB color format. Typically the x_{UV} is downsampled (resized) before processing with the encoding and decoding modules (neural networks). For example the size of the x_{UV} might be reduced by a factor of 50% in each of the vertical and horizontal dimensions. Therefore the processing of the secondary component includes approximately 50%×50%=25% less samples, therefore it is computationally less complex.

### 2.8 Cropping Operation in Neural Network Based Coding

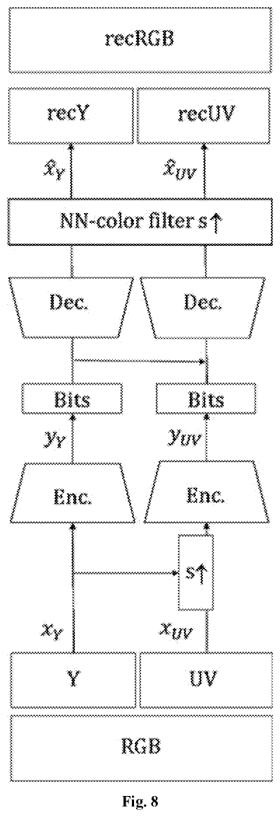

FIG. 9 illustrates synthesis transform example for learning based image coding.

The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2 ceil(W/2^{d}); here d is the depth of proceeding convolution in the codec architecture. For primary component Synthesis Transform receives input tensor with size h×w; h=ceil(H/16); w=ceil(W/16). The output of Synthesis Transform for primary component is 1×h₀×w₀, where h₀=H; h₀=W.

For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where h_{UV0}=ceil(H/s); h₀=ceil(W/s). For secondary components input sizes are h₀=ceil(H/s); w₀=ceil(W/s), where s is the scale factor. The scale factor might be 2 for example, wherein the secondary component is downsampled by a factor of 2.

Based on the above explanation, the operation of the cropping layers depend on the output size H,W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers are controlled by the output size H,W. In one example if H and W are both equal to 16, then the cropping layers do not perform any cropping. On the other hand if H and W are both equal to 17, then all 4 cropping layers are going to perform cropping.

### 2.9 Bitwise Shifting

The bitwise shift operator can be represented using the function bitshift(x, n), where n is an integer number. If n is greater than 0, it corresponds to right-shift operator (>>), which moves the bits of of the input to the right, and the left-shift operator (<<), which moves the bits to the left. In another words the bitshift(x, n) operation corresponds to:

$$bitshift ( x , n ) = x * {2}^{n} , or$$

$$bitshift ( x , n ) = floor ( x * {2}^{n} ) , or$$

$$bitshift ( x , n ) = x // {2}^{n} .$$

The output of the bitshift operation is an integer value. In some implementations, the floor( ) function might be added to the definition.

Floor(x) is equal to the largest integer less than or equal to x.

The “//” operator or the integer division operator: It is an operation that comprises division and truncation of the result toward zero. For example, 7/4 and −7/−4 are truncated to 1 and −7/4 and 7/−4 are truncated to −1.

$$rightshift ( x , n ) = x ≫ n or$$

$$leftshift ( x , n ) = x ≪ n$$

Equation 3: alternative implementation of the bitshift operator as rightshift or leftshift.

x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.

x<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution is a fairly simple operation at heart: you start with a kernel, which is simply a small matrix of weights. This kernel “slides” over the input data, performing an elementwise multiplication with the part of the input it is currently on, and then summing up the results into a single output pixel. In some cases the convolution operation might comprise a “bias”, which is added to the output of the elementwise multiplication operation. The convolution operation might be described by the following mathematical formula. An output outl can be obtained as:

$$out 1 [ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

wherein w1 are the multiplication factors, K1 is called a bias (an additive term) and Iₖ is the k^{th} input, and N is the kernel size in one direction and P is the kernel size in another direction. The convolution layer might consist of convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1$$

$$out [ c , x , y ] = c onv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out[1,x,y] is one output and out[2,x,y] is a second output. Wherein the k is the input number, I[1, x, y] is one input and I[2, x, y] is a second input.

The w1, or w describe weights of the convolution operation.

### 2.11 Leaky_Relu Activation Function

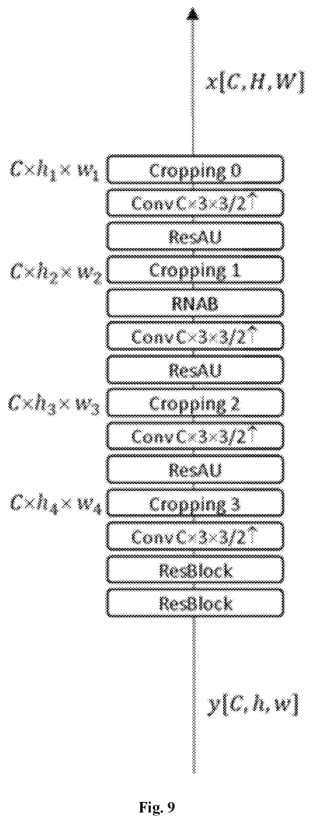

FIG. 10 illustrates Leaky Relu activation function.

The leaky_relu activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the leaky relu function.

### 2.12 Relu Activation Function

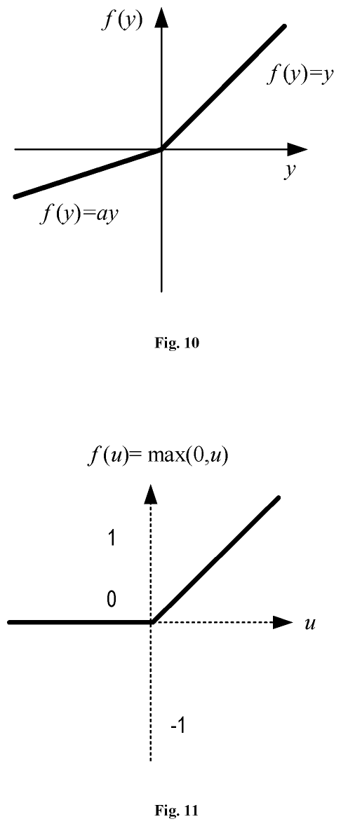

The relu activation function is depicted in FIG. 11. According to the function, if the input is a positive value, the output is equal to the input. If the input (y) is a negative value, the output is equal to 0.

### 2.13 the JPEG AI Image Coding Standard

The design in the latest JPEG AI draft specification utilizes some NN-based image coding methods described mentioned above. Some of the features in the latest JPEG AI specification are described or summarized below.

### 2.13.1 Bitstream Structure

The structure of a JPEG AI bitstream (also referred to as code stream or codestream) is composed of six parts with byte boundary, which are:
1) Start Of Codestream (SOC) marker;
2) Picture header;
3) Codestream of hyper tensor z, including \hat{z}_{γ} and \hat{z}_{UV};
4) Codestream of primary component residual, which includes \hat{r}_{γ};
5) Codestream of secondary component residual, which includes \hat{r}_{UV};
6) End Of Codestream (EOC) marker.

The overall syntax structure of an image is:

| | Descriptor |
|---|---|
| picture( ) { | |
| SOC | u(16) |
| picture_header( ) | |
| z_stream( ) | |
| r_primary_stream( ) | |
| r_secondary_stream( ) | |
| EOC | u(16) |
| } | |

### 2.13.2 Picture Header

This sub-stream contains information about image height H, width W, latent space tiles location and sizes, control flags for each tool, scaling factors for primary and secondary component, modelIdx—learnable model index and displacement for rate control parameters (β_Y for primary and β_UV for secondary component).

The syntax and semantics are as follows:

| | Descriptor |
|---|---|
| picture_header( ) { | |
| PIH | u(16) |
| picture_header_size | u(16) |
| img_width | u(16) |
| img_height | u(16) |
| picture_format | u(2) |
| bit_depth | u(1) |
| res_changer_header( ) | |
| icc_profile_header( ) | |
| model_header( ) | |
| EFE_upsampler_parameters ( ) | |
| ICCI_header( ) | |
| EFE_nonlinear_filter_parameters ( ) | |
| LEF_parameters( ) | |
| } | |

picture_header_size is the number of bytes in the picture header excluding the first two-byte marker;
img-width plus 64 specifies width of an input picture (from 64 to 65600);
imgfheight plus 64 specifies height of the input picture (from 64 to 65600);
picture_format is a data format of the output picture (YUV420=0, YUV444=1, sRGB=2, YUV444=3);
bit depth is a bit-depth the output picture (“0” corresponds to 8 and “1”, corresponds to 10);
tile_signaling_type is a type of signalling tiling information. When not present, the value of tile_signaling_type is inferred to be equal to 0.
tile enable_Luma and tile enable_Chroma are enable flags for tiling of primary and secondary components.
tile_size_Luma and tile_size_Chroma are size of tiles for primary and secondary components.
tile_overlap_Luma and tile overlap_Luma are sizes of tiles overlapping areas for primary and secondary components.

### Integer Division Operation:

“/” is typically used to describe integer division operation. x/y is equivalent to floor(x÷y), where ÷ is a regular division operation that can result in a fractional number.

### 3. Neural Network Layers Used in vi-Deo and Image Decoders and Encoders

### 3.1. Nearest Neighbour Up-Sampling

Denoted as s↑.This layer receives a tensor input of size [C, hᵢₙ, wᵢₙ] and outputs a tensor output of size [C, s·hᵢₙ, s·wᵢₙ].

No interpolation is needed for this down-sampling, just copy:

$$output [ c , i , j ] = input [ c , s \cdot i , s \cdot j ] , i = 0 , … , {h}_{i n} - 1 , j = 0 , … , {w}_{i n} - 1 , c = 0 , … , C - 1.$$

### 3.2. Nearest Neighbour Down-Sampling

Denoted as (s1, s2)↓(or s1 if s1=s2=s). This layer receives a tensor input of size [C, s1·hₒᵤₜ, s2·wₒᵤₜ] and outputs a tensor output of size [C, hₒᵤₜ, wₒᵤₜ] procedure by which the spatial resolution of each tensor channel decreased.

No interpolation is needed for this down-sampling, just copy:

$$output [ c , i , j ] = input [ c , s 1 \cdot i , s 2 \cdot j ] , i = 0 , … , {h}_{i n} - 1 , j = 0 , … , {w}_{i n} - 1 , c = 0 , … , C - 1.$$

### 3.3. Grouped Convolution Layer

Two-dimensional grouped convolution is denoted as gCONV (Kᵥₑᵣ×Kₕₒᵣ, Cᵢₙ, Cₒᵤₜ, G, s↓). The convolution layer receives a tensor of size [Cᵢₙ, hᵢₙ, wᵢₙ] and outputs a tensor of size[Cₒᵤₜ, hₒᵤₜ, wₒᵤₜ], where hᵢₙ=s·hₒᵤₜ; wᵢₙ=s·wₒᵤₜ. G represent the number of groups, it controls the connections between inputs and outputs. Cᵢₙ and Cₒᵤₜ must be divisible by G. Factor s is called stride. In absence of stride argument no spatial resolution change is performed.

$$For g = 0 , … , G - 1 ,$$

$$For {c}_{out} = g \cdot {C}_{out} / G , … , ( g + 1 ) \cdot {C}_{out} / G - 1 , out [ {c}_{o u t} , i , j ] = bias [ {c}_{out} ] + {\sum }_{{g}^{′} = 0}^{G} w e i g t h [ {g}^{′} , {c}_{o u t} ] ⋆ input [ g \cdot {C}_{i n} / G + {g}^{′} , s \cdot i , s \cdot j ] ;$$

$$0 \leq i < {h}_{o u t} , 0 \leq j < {w}_{o u t} ,$$

where “*” is 2D cross-correlation operator with kernel size

$${K}_{ν e r} \times {K}_{h o r} : b ⋆ a [ i , j ] = {\sum }_{{j}^{′} = - ( {K}_{h o r - 1 ) / 2}}^{{j}^{′} = {K}_{hor} / 2} {\sum }_{{i}^{′} = - ( {K}_{ν e r} - 1 ) / 2}^{{i}^{′} = {K}_{ν e r} / 2} b [ {i}^{′} , {j}^{′} ] ⋆ a [ i + {i}^{′} , j + {j}^{′} ] . If i + {i}^{′} < 0 or i + {i}^{′} \geq {h}_{i n} or j + j < 0 or j + {j}^{′} \geq {w}_{i n}$$

then elements α[i+i′, j+j′] are equal to zero.

The tensor weight of shape [Cᵢₙ/G, Cₒᵤₜ, Kᵥₑᵣ, Kₕₒᵣ] contains learnable weights, the tensor bias of shape [Cₒᵤₜ,] contains learnable biases. All parameters weight and bias are part of learnable model.

### 3.4. Pixel Shuffle Layer

pixel shuffle layer, also known as sub-pixel convolution, is denoted as PixelShuffle(s1,s2), where s1 and s2 are the scale factors. This layer rearranges elements in a tensor input of shape [Cᵢₙ, hᵢₙ, wᵢₙ] to a tensor output of shape[Cₒᵤₜ, hₒᵤₜ,wₒₙₜ], where hₒᵤₜ=s1·hᵢₙ; wₒᵤₜ=s2·wᵢₙ; Cₒᵤₜ=Cᵢₙ/(s1·s2).

For c=0, . . . , Cₒᵤₜ−1, i=0, . . . , hₒᵤₜ−1 and j=0, . . . , wₒᵤₜ−1,
for i′=0. . . s1−1 and j′=0 . . . s2−1,

$$output [ c , i , j ] = input [ c * s 1 * s 2 + s 2 + {j}^{′} , i / s 1 + {i}^{′} , j / s 2 + {j}^{′} ] .$$

### 3.5. Concatenation of Tensors

the input of this process is two tensors of same spatial size: input₁[C₁, h, w] and input₂ [C₁, h, w]. The output of this process is a tensor of [C₁+C₂, h, w], which contains elements of both input tensors:

$$output [ c , i , j ] = ( c < {C}_{1} ) ? {input}_{1} [ c , i , j ] : {input}_{2} [ c , i , j ] ; \\ 0 \leq c < {C}_{1} + {C}_{2} , 0 \leq i < h , 0 \leq j < w .$$

### 3.6. Latent Combine Block

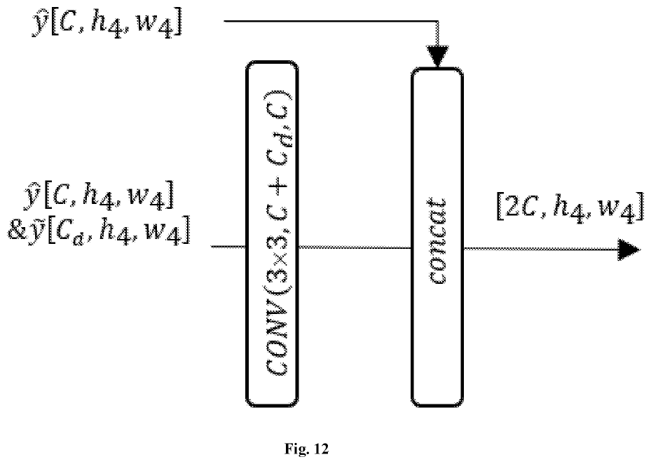

Latent Combine Block is denoted as LCB(C, C_{d}, C₁). This module receives two tensors of size [C, h₄, w₄] and [C+C_{d}, h₄, w₄]. Convolution with stride 1 and size 3×3 reduces the number of channels for second input tensor to C. The output of convolution is concatenated with first input tensor, so the output tensor has size [2C, h₄, w₄]. Latent Combine Block operations are depicted on FIG. 12. Note that LCB used for secondary component, and so C₃=2C.

### 3.7. Max Pooling

Denotes as MaxPool(k, input). This layer receives a tensor input of size [C, hᵢₙ, wᵢₙ] and outputs a tensor output of size [C, hₒᵤₜ, wₒᵤₜ], hₒᵤₜ=hₒᵤₜ/k, wₒᵤₜ=wₒᵤₜ/k, constructed as follows:

$$output [ c , i , j ] = {max}_{m = 0 , …} {max}_{, k - 1 n = 0 , … , k - 1} input [ c , i + m , j + n ] , i = 0 , … , {h}_{o u t} - 1 ; j = 0 , … , {w}_{o u t} - 1 ; c = 0 , … , C - 1.$$

### 3.8. Min Pooling

Denotes as MinPool(k, input). This layer receives a tensor input of size [C, hᵢₙ, wᵢₙ] and outputs a tensor output of size [C, hₒᵤₜ, wₒᵤₜ], hₒᵤₜ=hₒᵤₜ/k, wₒᵤₜ=wₒᵤₜ/k, constructed as follows:

$$output [ c , i , j ] = {max}_{m = 0 , …} {max}_{, k - 1 n = 0 , … , k - 1} input [ c , i + m , j + n ] , i = 0 , … , {h}_{o u t} - 1 ; j = 0 , … , {w}_{o u t} - 1 ; c = 0 , … , C - 1.$$

### 3.9. Avg Pooling

Denotes as AvgPool(k, input). This layer receives a tensor input of size [C, hᵢₙ, wᵢₙ] and outputs a tensor output of size [C, hₒᵤₜ, wₒᵤₜ], hₒᵤₜ=ceil(hₒᵤₜ/k), wₒᵤₜ=ceil(wₒᵤₜ/k), constructed as follows:

$$output [ c , i , j ] = ( {\sum }_{m = 0}^{k - 1} {\sum }_{n = 0}^{k - 1} input [ c , i + m , j + n ] ) / {k}^{2} , i = 0 , … , {h}_{o u t} - 1 ; j = 0 , … , {w}_{o u t} - 1 ; c = 0 , … , C - 1 .$$

### 4. Problems

The existing design includes implementation of neural network layers that are not friendly for implementation in hardware. The hardware implementation typically means implementation on a platform that is not general purpose such as CPU. A central processing unit of a device is typically engineered to perform all kinds of processing, from image decoding to decryption to performing scientific calculations.

On the other hand an image and video codec that is based on neural network (NN) operations utilize only a very limited set of tensor operations, a specialized processing unit such as GPU, or even an NPU (Neural processing unit) can run the codec very efficiently (fast and energy efficiently).

In order to run a codec that is primarily based on NN operations on an NPU (or GPU), the operations should be highly parallelizable. If all samples of an output tensor can be obtained using the exact same operation, the processing layer (i.e. the operation that needs to be performed to obtain the output sample) can be implemented very efficiently. As a second example if the input and output size of each processing layer are same, the process can be performed efficiently since the processing load of each layer would be equal. On the other hand, if the size of the output tensor of each layer gets gradually smaller, the processing load of the processing layers would be unbalanced (not equal), and the computational efficiency would reduce.

Therefore it is important that the processing layers (e.g. convolution, activation, pooling etc) should be balanced.

4.1. Initization of newly generated samples

The upsampling layer typically describes how the size of an input tensor could be increased. In section 3.1, the implementation of the upsampling operation in current JPEG AI committee draft is defined. The definition however does not describe how the new samples resulting from the size increase are obtained. Therefore, an encoder from one manufacturer and a decoder from another manufacturer might not work together, as they might not initialize the new samples resulting from the size increase in the same manner.

### 4.2. Not Possible to Encode/Decode Some Images if the Size of the Image has a Certain Value

In section 3.2, the implementation of the upsampling layer in current JPEG AI committee draft is defined. The relation between input and output size is described as input of size [C, s1·hₒᵤₜ, s2·wₒᵤₜ] and outputs a tensor output of size [C, hₒᵤₜ, wₒᵤₜ]. Since s1 and s2 are downsampling ratios in the vertical and horizontal direction, and since the size of the output tensor must be integer (the width and height of a tensor cannot be fractional number), the size of the input image is restricted to be multiple of s1 and s2 in vertical and horizontal direction respectively.

An input image that for example has a size (height=100*s1+1, width=120*s2+s2−1)) cannot be processed by the encoder and decoder.

### 4.3. Missing Padding Operations

Some of the operations such as pooling operations do not include any padding operation. For example if the pooling operation has a kernel size of 8×8, any input that needs to be processed by this layer must be multiple of 8 in horizontal and vertical direction. This severely restricts the sizes of input tensors that can be processed. Furthermore how the padding operation is performed can affect the performance a lot. A replication padding, (using the value of a nearest sample) is an operation that is not suitable for implementation in GPU or NPU. The process is slow, since the operation is not identical for each sample (the output value depends on the value of a neighbor sample).

Padding with a zero might also be detrimental to the performance, as the result of an averaging (average pooling) operation might be distorted a lot (especially if the values of the samples that are pooled are too different from 0).

### 5. Detailed Solutions

According to some embodiments of the present disclosure, and image or video compression/decompression method is proposed, wherein processing layers used in the compression/decompression can be implemented efficiently.

1. An upsampling layer might be used wherein:
a. The upsampling might performed based on a neighbor sample.
   i. The neighbor might be top-right, top-left, bottom-left or bottom-right neighbor.
   ii. The up sampling might be performed based on the nearest neighbor sample in only one quarter region.
      1. The quarter region might be top-right, top-left, bottom-left or bottom-right quarter region.
         a. if the quarter region is a top-left quarter, a value of a sample is determined based on the nearest sample which is in either top, left or top-left direction.
         b. if the quarter region is a top-right quarter, a value of a sample is determined based on the nearest sample which is in either top, right or top-right direction.
         c. if the quarter region is a bottom-right quarter, a value of a sample is determined based on the nearest sample which is in either bottom, right or bottom-right direction.
         d. if the quarter region is a bottom-left quarter, a value of a sample is determined based on the nearest sample which is in either bottom, left or bottom-left direction.
   2. The up sampling might described as follows:
   b. The upsampling might performed based on two upsampling ratios.
      i. The first upsampling ratio might correspond to a vertical direction and the second upsampling ratio might correspond to a horizontal direction.
      ii. The two upsampling ratios might be indicated in a bitstream.
   c. The upsampling might performed based on a division operation of an index.
      i. The division operation might be an integer division operation.
      ii. The index might indicate a horizontal or a vertical coordinate of a sample.
   d. The new samples generated by upsampling process might be initialized based on a neighbor sample.

2. A downsampling layer might be used wherein:
a. The downsampling might performed based on a multiplication operation of an index.
   i. The index might indicate a horizontal or a vertical coordinate of a sample.
b. The sizes of the input tensor and the output tensor might obey the following equation:
   i. hᵢₙ=s1·hₒᵤₜ+n, wherein the hᵢₙ is the vertical size of the input tensor, hₒᵤₜ is the vertical size of the output tensor and n is a non-negative integer.
      1. n might be smaller than s1.
   ii. wᵢₙ=s2·wₒᵤₜ+m, wherein the win is the horizontal size of the input tensor, wₒᵤₜ is the horizontal size of the output tensor and m is a non-negative integer.
      1. m might be smaller than s2.

3. A group convolution operation wherein:
a. The convolution operation is performed based on an input tensor and an output tensor, wherein the tensors have at least 3 dimensions.
   i. The dimensions might comprise a width, a height and a channel number (3^{rd} dimension).
   ii. A sample of the output tensor might be obtained based on K channels of the input tensor.
      1. The K might depend on the number of input channels and a number G that represents number of groups.
      2. The K might be obtained by dividing the number of channels with number of groups.
      3. Number of groups might be greater than 1.
      4. A sample of the output tensor might only depend on sample of K channels and not the samples of other channels.
      5. Obtaining of a sample of the output tensor might be based on the following equation:

$$out [ {c}_{o u t} , i , j ] = bias [ {c}_{o u t} ] + {\sum }_{{g}^{′} = 0}^{{C}_{i n} / G - 1} weigth [ {g}^{′} , {c}_{o u t} ] ⋆ input [ g \cdot {C}_{i n} / G + {g}^{′} , s \cdot i , s \cdot j ] ;$$

4. A pixel shuffle operation wherein:
a. The pixel shuffle operation might be performed based on a modulo operation.
b. The said pixel shuffle operation might reorder the sample of the input tensor.
c. One sample of the output tensor might be obtained according to the following equation:

$$input\_p [ c , i , j ] = \{ \begin{matrix}input [ c , i , j ] if 0 \leq i < {h}_{in} and 0 \leq j < {w}_{in} \\ M otherwise\end{matrix}$$

5. A pooling layer might be used wherein:
a. The sizes of the input tensor and the output tensor might obey the following equation:
   i. hᵢₙ=k·hₒᵤₜ+n,
   ii. wᵢₙ=k·wₒᵤₜ+m,
   iii. hₒᵤₜ=(hᵢₙ+k−1)/k,
   iv. wₒᵤₜ=(wᵢₙ+k−1)/k,
   v. wherein the hᵢₙ is the vertical size of the input tensor, hₒᵤₜ is the vertical size of the output tensor and n is a non-negative integer. The win is the horizontal size of the input tensor, wₒᵤₜ is the horizontal size of the output tensor and m is a non-negative integer.
   vi. k might be a kernel size of the pooling operation.
      1. n might be smaller than k.
      2. m might be smaller than k.
   vii. “/” might represent an integer division operation.
b. The size of the input tensor might be increased first before the pooling is applied.
   i. A padding operation might be performed.
   ii. The padding operation might be padding with a constant value.
      1. The padding value might be adjustable.
      2. The padding value might be M.
      3. The padding value might be an integer value.
      4. The value might depend on a model, e.g. a model index, wherein the model might comprise the weights (e.g. multiplicative coefficients) or biases used in decoding of an image.
      5. The value M might be determined based on an average expected value.
      6. The value M might be different from 0.
      7. The value M might be equal to 0.
   iii. The amount of padded samples might depend on a kernel size.
   iv. The amount of padded samples might depend on input tensor size.
   v. The amount of padded samples might depend on output tensor size.
   vi. The output tensor size might be determined to be integer multiple of kernel size.
   vii. The number of padded samples might be according to input tensor size, output tensor size and kernel size.
      1. The number of padded samples might be equal to hₒᵤₜ*k−hᵢₙ, wherein hₒᵤₜ and hᵢₙ are height of the output and input tensors.
      2. The number of padded samples might be equal to wₒᵤₜ*k−wᵢₙ, wherein wₒᵤₜ and win are width of the output and input tensors.
   viii. The padding might be done at the right boundary and/or at the bottom boundary.
   ix. The padding operation might be as follows:
c. The pooling operation might be an average pooling, max pooling or min pooling.
d. The average pooling operation might be performed based on a bitshift operation or an integer division operation.
   i. The division or the bitshift might be based on the kernel size.
      1. The divisor might be equal to k².
      2. The bitshift amount might be equal to 2*log 2(k).
      3. Bit bitshift amount might be 6.
      4. The divisor might be equal to 64.
   ii. An offset value might be added to the average before division or bitshift operation.
      1. The offset value might depend on the divisor or the bitshift amount.
      2. The offset value might be equal to k²/2.
      3. The offset value might be equal to 32.
e. The output tensor of the average pooling layer might be obtained as follows:

$$output [ c , i , j ] = ( \frac{{k}^{2}}{2} + {\sum }_{m = 0}^{k - 1} {\sum }_{n = 0}^{k - 1} input\_p [ c , i * k + m , j * k + n ] ) / {k}^{2} ,$$

f. The output tensor of the max pooling layer might be obtained as follows:

$$output [ c , i , j ] = {max}_{m = 0 , …} {max}_{, k - 1 n = 0 , … , k - 1} {input}_{p [ c , i + m , j + n ]}$$

g. The output tensor of the min pooling layer might be obtained as follows:

$$output [ c , i , j ] = {min}_{m = 0 , …} {min}_{, k - 1 n = 0 , … , k - 1} input\_ p [ c , i + m , j + n ] ,$$

### 6. Embodiments

Below are some example embodiments for the detailed solutions aspects summarized above in Section 5.

6.1. Top-Left Quarter Neighbour Up-Sampling Denoted as (s1, s2)↑(or s↑ if s1=s2=s). This layer receives a tensor input of size [C, hᵢₙ, wᵢₙ] and outputs a tensor output of size [C, s·hᵢₙ, s·wᵢₙ].

No interpolation is needed for this up-sampling, just copy:

$$output [ c , i , j ] = input [ c , i / s 1 , j / s 2 ] , i = 0 , … , {h}_{o u t} - 1 , j = 0 , … , {w}_{o u t} - 1 , c = 0 , … , C - 1.$$

### 6.2. Top-Left Quarter Neighbour Down-Sampling

Denoted as (s1, s2)↓(or s↓ if s1=s2=s). This layer receives a tensor input of size [C, hᵢₙ, wᵢₙ] and outputs a tensor output of size [C, hₒᵤₜ, wₒᵤₜ] procedure by which the spatial resolution of each tensor channel decreased. The input size might be equal to hᵢₙ=s1·hₒᵤₜ+n, wᵢₙ=s2·wₒᵤₜ+m, wherein n and m are non-negative integers smaller than s1 and s2 respectively.

$$output [ c , i , j ] = input [ c , s 1 \cdot i , s 2 \cdot j ] , i = 0 , … , {h}_{o u t} - 1 , j = 0 , … , {w}_{o u t} - 1 , c = 0 , … , C - 1 .$$

### 6.3. Grouped Convolution Layer

two-dimensional grouped convolution is denoted as gCONV (Kᵥₑᵣ×Kₕₒᵣ, Cᵢₙ, Cₒᵤₜ, G, s↓). The convolution layer receives a tensor of size [Cᵢₙ, hᵢₙ, wᵢₙ] and outputs a tensor of size[Cₒᵤₜ, hₒᵤₜ, wₒᵤₜ], where hᵢₙ=s·hₒᵤₜ; wᵢₙ=s·wₒᵤₜ. G represent the number of groups, it controls the connections between inputs and outputs. Cᵢₙ and Cₒᵤₜ must be divisible by G. Factor s is called stride. In absence of stride argument no spatial resolution change is performed.
For g=0, . . . , G−1,
For cₒᵤₜ=g·Cₒᵤₜ/G, . . . , (g+1)·Cₒᵤₜ/G−1,

$$out [ {c}_{o u t} , i , j ] = bias [ {c}_{o u t} ] + {\sum }_{{g}^{′} = 0}^{{C}_{i n} / G - 1} weigth [ {g}^{′} , {c}_{o u t} ] ⋆ {input}_{p} [ g \cdot {C}_{i n} / G + {g}^{′} , s \cdot i , s \cdot j ] ; \\ 0 \leq i < {h}_{o u t} , 0 \leq j < {w}_{o u t}$$

where “*” is 2D cross-correlation operator with kernel size Kᵥₑᵣ×Kₕₒᵣ: b*α[i, j]=

$${\sum }_{{j}^{′} = - ( {K}_{h o r} - 1 ) / 2}^{{j}^{′} = {K}_{hor} / 2} {\sum }_{{i}^{′} = - ( {K}_{ν e r} - 1 ) / 2}^{{i}^{′} = {K}_{ν e r} / 2} b [ {i}^{′} , {j}^{′} ] \cdot a [ i + {i}^{′} , j + {j}^{′} ] . \\ If i + {i}^{′} < 0 or i + {i}^{′} \geq {h}_{i n} or j + j < 0 or j + {j}^{′} \geq {w}_{in}$$

wᵢₙ then elements α[i+i′, j+j′] are equal to zero.

The tensor weight of shape [Cᵢₙ/G, Cₒᵤₜ, Kᵥₑᵣ, Kₕₒᵣ] contains learnable weights, the tensor bias of shape [Cₒᵤₜ,] contains learnable biases. All parameters weight and bias are part of learnable model.

### 6.4. Pixel Shuffle Layer

pixel shuffle layer, also known as sub-pixel convolution, is denoted as PixelShuffle(s1, s2), where s1 and s2 are the scale factors. This layer rearranges elements in a tensor input of shape [Cᵢₙ, hᵢₙ, wᵢₙ] to a tensor output of shape[Cₒᵤₜ, hₒᵤₜ, wₒᵤₜ], where hₒᵤₜ=s1·hᵢₙ; wₒᵤₜ=s2·wᵢₙ; Cₒᵤₜ=Cᵢₙ/(s1·s2).

$$For c = 0 … {C}_{o u t} - 1 , i = 0 … {h}_{o u t} - 1 and j = 0 … {w}_{o u t} - 1 , output [ c , i , j ] = input [ c \cdot s 1 \cdot s 2 + ( i \% s 1 ) \cdot s 2 + j \% s 2 , i / s 1 , j / s 2 ] .$$

### 6.5. Concatenation of Tensors

the input of this process is two tensors of same spatial size: input₁[C₁, h, w] and input₂ [C₂, h, w]. The output of this process is a tensor of [C₁+C₂, h, w], which contains elements of both input tensors:

$$output [ c , i , j ] = ( c < {C}_{1} ) ? {input}_{1} [ c , i , j ] : {input}_{2} [ c , i , j ] ; \\ 0 \leq c < {C}_{1} + {C}_{2} , 0 \leq i < h , 0 \leq j < w .$$

### 6.6. Latent Combine Block

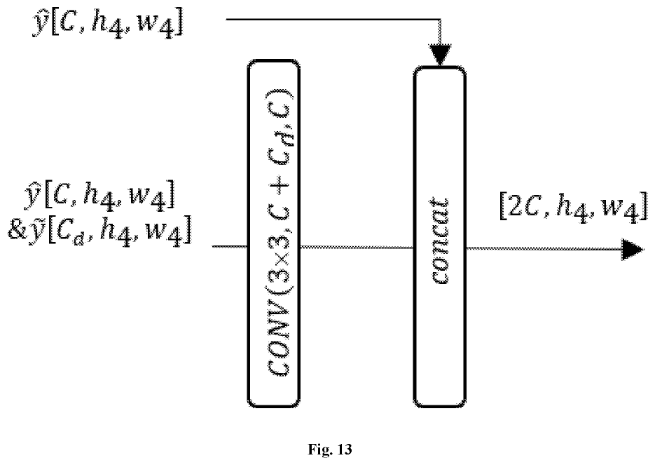

Latent Combine Block is denoted as LCB(C, C_{d}). This module receives a first tensor ŷ[C, h₄, w₄] and a second tensor ŷ[C_{d}, h₄, w₄]. ŷ and ŷ are concatenated with input1 set equal to ŷ and input2 equal to ŷ. Convolution with stride 1 and size 3×3 reduces the number of channels for second input tensor to C. The output of convolution is concatenated with 9, wherein input1 is set equal to output of the convolution and input2 is set equal to ŷ, so the output tensor has size [2C, h₄, w₄]. Latent Combine Block operations are depicted on FIG. 13. Note that LCB used for secondary component, and so C₃=2C.

### 6.7. Max Pooling

Denotes as MaxPool(k, input, M). This layer receives a tensor input of size [C, hᵢₙ, wᵢₙ] and outputs a tensor output of size [C, hₒᵤₜ, wₒᵤₜ], hₒᵤₜ=(hᵢₙ+k−1)/k, wₒᵤₜ=(wᵢₙ+k−1)/k, constructed as follows: Firstly the input tensor extended (padded) in width and height dimensions. The amount of padding samples depend on the kernel size.

$$For c = 0 , … , C - 1 , i = 0 , … , {h}_{o u t} * k - 1 , j = 0 , … , {w}_{o u t} * k - 1 ;$$

$${input}_{p} [ c , i , j ] = \{ \begin{matrix}input [ c , i , j ] & if 0 \leq i < {h}_{i n} and 0 \leq j < {w}_{i n} \\ M & otherwise\end{matrix}$$

Secondly the following assignment is made:

$$output [ c , i , j ] = {max}_{m = 0 , … , k - 1} {max}_{n = 0 , … , k - 1} {input}_{p [ c , i + m , j + n ]}$$

$$wherin i = 0 , … , {h}_{o u t} - 1 ; j = 0 , … , {w}_{o u t} - 1 ; c = 0 , … , C - 1 .$$

### 6.8. Min Pooling

Denoted as MinPool(k, input, M). This layer receives a tensor input of size [C, hᵢₙ, wᵢₙ] and outputs a tensor output of size [C, hₒᵤₜ, wₒᵤₜ], hₒᵤₜ=(hᵢₙ+k−1)/k, wₒᵤₜ=(wᵢₙ+k−1)/k, constructed as follows: Firstly the input tensor extended (padded) in width and height dimensions. The amount of padding samples depend on the kernel size.

$$For c = 0 , … , C - 1 , i = 0 , … , {h}_{o u t} * k - 1 , j = 0 , … , {w}_{o u t} * k - 1 ;$$

$${input}_{p} [ c , i , j ] = \{ \begin{matrix}input [ c , i , j ] & if 0 \leq i < {h}_{i n} and 0 \leq j < {w}_{i n} \\ M & otherwise\end{matrix}$$

Secondly the following assignment is made:

$$output [ c , i , j ] = {max}_{m = 0 , … , k - 1} {max}_{n = 0 , … , k - 1} {input}_{p} [ c , i + m , j + n ] ,$$

$$wherein i = 0 , … , {h}_{o u t} - 1 ; j = 0 , … , {w}_{o u t} - 1 ; c = 0 , … , C - 1 .$$

### 6.9. Avg Pooling

Denoted as AvgPool(k, input, M). This layer receives a tensor input of size [C, hᵢₙ, wᵢₙ] and outputs a tensor output of size [C, hₒᵤₜ, wₒᵤₜ], hₒᵤₜ=(hᵢₙ+k−1)/k, wₒᵤₜ=(wᵢₙ+k−1)/k, constructed as follows: Firstly the input tensor extended (padded) in width and height dimensions. The amount of padding samples depend on the kernel size.

For c=0, . . . , C−1, i=0, . . . , hₒᵤₜ*k−1,j=0, . . . , wₒᵤₜ*k−1);

$${input}_{p} [ c , i , j ] = \{ \begin{matrix}input [ c , i , j ] & if 0 \leq i < {h}_{i n} and 0 \leq j < {w}_{i n} \\ M & otherwise\end{matrix}$$

Secondly the following assignment is made:

$$output [ c , i , j ] = ( \frac{{k}^{2}}{2} + {\sum }_{m = 0}^{k - 1} {\sum }_{n = 0}^{k - 1} {input}_{p} [ c , i * k + m , j * k + n ] ) / {k}^{2} ,$$

wherein i=0, . . . , hₒᵤₜ−1; j=0, . . . , wₒᵤₜ−1; c=0, . . . , C−1.

More details of the embodiments of the present disclosure will be described below which are related to neural network-based visual data coding. As used herein, the term “visual data” may refer to an image, a picture in a video, or any other visual data suitable to be coded.

As discussed above, in the existing design for neural network (NN)-based visual data coding, pooling operations do not include any padding operation. For example, if a pooling layer has a kernel size of 8×8, any input that needs to be processed by this pooling layer must be a multiple of 8 in horizontal and vertical directions. This severely restricts the sizes of input tensors that can be processed. Therefore, the coding flexibility decreases.

To solve the above problems and some other problems not mentioned, visual data processing solutions as described below are disclosed. The embodiments of the present disclosure should be considered as examples to explain the general concepts and should not be interpreted in a narrow way.

Furthermore, these embodiments can be applied individually or combined in any manner.

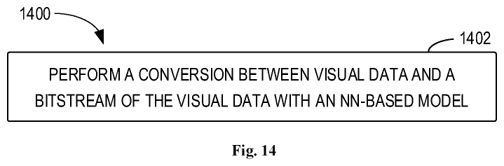

FIG. 14 illustrates a flowchart of a method 1400 for visual data processing in accordance with some embodiments of the present disclosure. At 1402, a conversion between the visual data and a bitstream of the visual data is performed with a neural network (NN)-based model. In some embodiments, the conversion may include encoding the visual data into the bitstream. Additionally or alternatively, the conversion may include decoding the visual data from the bitstream. By way of example rather than limitation, the decoding model shown in FIG. 7 may be employed for decoding the visual data from the bitstream.

As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

In addition, a pooling layer in the NN-based model is configured to be applied with a padding operation that is used for padding at least one sample for an input tensor of the pooling layer. As used herein, the input tensor of a layer may refer to an input to the layer. In some embodiments, all of the at least one sample may be padded with a same padding value. For example, the padding value is represented by M. In one example embodiment, the padding value may be equal to 0. Such a padding operation is also known as zero padding. In another example embodiment, the padding value may be not equal to 0, such as 128, 512, 1411, or the like. In aid of non-zero padding value, the performance of the pooling layer can be ensured. In a further example embodiment, the padding value may be adjustable.

Alternatively, the padding value may be dependent on a model or an average expected value. In some further embodiments, the at least one sample may be padded with different padding values, e.g., dependent on a position of a sample to be padded.

In view of the above, a pooling layer in the NN-based model is configured to be applied with a padding operation that is used for padding at least one sample for an input tensor of the pooling layer.

Compared with the conventional solution where a pooling layer does not include any padding operation, the proposed method can advantageously support various possible sizes of the input tensor of the pooling layer. Thereby, the coding flexibility and coding efficiency can be improved.

In some embodiments, the number of the at least one sample may be dependent on a size of the input tensor and a kernel size of the pooling layer. For example, the at least one sample may comprise one or more samples that are outside the input tensor and inside a kernel of the pooling layer. In one example embodiment, the at least one sample may comprise one or more samples at a right boundary of the input tensor and/or one or more samples at a bottom boundary of the input tensor. In addition, the number of the at least one sample may be further dependent on a size of an output tensor of the pooling layer.

In some embodiments, the padding operation may be performed as follows:
if i≥hᵢₙ or j≥wᵢₙ, input[c, i, j] may be set to be equal to M,
where input[ ] represents the input tensor of the pooling layer, c represents a channel index of a sample, i represents a height index of the sample, j represents a width index of the sample, M represents a padding value, hᵢₙ represents a height of the input tensor, and wᵢₙ represents a width of the input tensor.

In some embodiments, the pooling layer may comprise an average pooling layer, and the average pooling layer may be configured to be applied with a bit-shift operation. A bit-shift amount of the bit-shift operation may be dependent on a kernel size of the average pooling layer. For example, the bit-shift amount may be equal to 2×log 2(k), and k represents the kernel size. By way of example rather than limitation, the kernel size may be equal to 8, and the bit-shift amount may be equal to 6. It should be understood that the specific values recited herein are intended to be exemplary rather than limiting the scope of the present disclosure.

In some embodiments, a current sample of an output of the pooling layer may be determined by: determining a sum of a plurality of samples associated with the input tensor, wherein if the plurality of samples comprise one or more samples outside the input tensor, the one or more samples may be padded with the padding operation; obtaining an intermediate result by adding an offset value to the sum; and applying a bit-shift operation on the intermediate result to obtain the current sample. For example, at least one of the following may be dependent on a kernel size of the pooling layer: the number of the plurality of samples, the offset value, or a bit-shift amount of the bit-shift operation. In some alternative embodiments, an integer division operation may be used to replace the bit-shift operation, since there is an equivalence between these two operations.

In some embodiments, an output tensor of the pooling layer may be determined as follows:

$$output [ c , i , j ] = ( \frac{{k}^{2}}{2} + {\sum }_{m = 0}^{k - 1} {\sum }_{n = 0}^{k - 1} input [ c , i * k + m , j * k + n ] ) >> ( 2 * log 2 ( k ) ) ,$$

where i=0, . . . , hₒᵤₜ−1; j=0, . . . , wₒᵤₜ−1; c=0, . . . , C−1, and if i*k+m≥hᵢₙ or j*k+n≥wᵢₙ, input[c, i*k+m, j*k+n] is set to be equal to M, and output[ ] represents the output tensor, k represents a kernel size of the pooling layer, input[ ] represents the input tensor of the pooling layer, hₒᵤₜ represents a height of the output tensor, wₒᵤₜ represents a width of the output tensor, C represents the number of channels of the output tensor, hᵢₙ represents a height of the input tensor, wᵢₙ represents a width of the input tensor, and M represents a padding value.

It should be note that the above equation is equivalent to the following equation:

$$output [ c , i , j ] = ( \frac{{k}^{2}}{2} + {\sum }_{m = 0}^{k - 1} {\sum }_{n = 0}^{k - 1} input [ c , i * k + m , j * k + n ] ) / {k}^{2}$$

where “/” represents an integer division operation (with rounding), and x/y=floor (x÷y), x>=0, y>0.

In some embodiments, a size of an output tensor of the pooling layer may be determined as follows:

$${h}_{o u t} = ( {h}_{i n} + k - 1 ) >> log 2 ( k ) ,$$

$${w}_{o u t} = ( {w}_{i n} + k - 1 ) >> log 2 ( k ) ,$$

where hₒᵤₜ represents a height of the output tensor, wout represents a width of the output tensor, hin represents a height of the input tensor, wᵢₙ represents a width of the input tensor, and k represents a kernel size of the pooling layer. By way of example, the kernel size k may be equal to 8 or the like.

It should be note that the above two equations are equivalent to the following two equations:

$${h}_{o u t} = ( {h}_{i n} + k - 1 ) / k ,$$

$${w}_{o u t} = ( {w}_{i n} + k - 1 ) / k ,$$

where “/” represents an integer division operation (with rounding).

In some further embodiments, the pooling layer may comprise a max pooling layer, and an output tensor of the max pooling layer may be determined as follows:

$$output [ c , i , j ] = {max}_{m = 0 , … , k - 1} {max}_{n = 0 , … , k - 1} input [ c , i + m , j + n ]$$

where i=0, . . . , hₒᵤₜ−1; j=0, . . . , wₒᵤₜ−1; c=0, . . . , C−1, and if i*k+m≥hᵢₙ or j*k+n≥wᵢₙ, input[c, i+m,j+n] is set to be equal to M, and output[ ] represents the output tensor, k represents a kernel size of the pooling layer, input[ ] represents the input tensor of the max pooling layer, hₒᵤₜ represents a height of the output tensor, wₒᵤₜ represents a width of the output tensor, C represents the number of channels of the output tensor, hᵢₙ represents a height of the input tensor, wᵢₙ represents a width of the input tensor, and M represents a padding value.

In some still further embodiments, the pooling layer may comprise a min pooling layer, and an output tensor of the min pooling layer may be determined as follows:

$$output [ c , i , j ] = {min}_{m = 0 , … , k - 1} {min}_{n = 0 , … , k - 1} [ c , i + m , j + n ] ,$$

where i=0, . . . , hₒᵤₜ−1; j=0, . . . , wₒᵤₜ−1; c=0, . . . , C−1, and if i*k+m≥hᵢₙ or j*k+n≥wᵢₙ, input[c, i+m, j+n] may be set to be equal to M, and output[ ] represents the output tensor, k represents a kernel size of the pooling layer, input[ ] represents the input tensor of the min pooling layer, hₒᵤₜ represents a height of the output tensor, wₒᵤₜ represents a width of the output tensor, C represents the number of channels of the output tensor, hᵢₙ represents a height of the input tensor, wᵢₙ represents a width of the input tensor, and M represents a padding value.

In some embodiments, the NN-based model may comprise a downsampling layer configured to be applied based on a multiplication operation of an index of a sample. For example, the index may indicate a horizontal coordinate (e.g., a width index) or a vertical coordinate (e.g., a height index) of the sample.

In some embodiments, a size of an input of the downsampling layer and a size of an output of the downsampling layer have the following relationship:

$${h}_{i n} = s1\_d \cdot {h}_{o u t} + n ,$$

$${w}_{i n} = s2\_d \cdot {w}_{o u t} + m ,$$

where hᵢₙ represents a height of the input, wᵢₙ represents a width of the input, hₒᵤₜ represents a height of the output, wₒᵤₜ represents a width of the output, each of s1_d and s2_d represents a downsampling ratio of the downsampling layer, and each of n and m may be a non-negative integer.

In some embodiments, an output of the downsampling layer may be determined as follows:

$$output\_d [ c , i , j ] = input\_d [ c , s1\_d \cdot i , s2\_d \cdot j ] ,$$

where i=0, . . . ,hₒᵤₜ−1; j=0, . . . ,wₒᵤₜ−1; c=0, . . . , C−1, and output_d[ ] represents the output of the downsampling layer, input_d[ ] represents an input of the downsampling layer, s1_d represents a first downsampling ratio, s2_d represents a second downsampling ratio, hₒᵤₜ represents a height of the output, wₒᵤₜ represents a width of the output, C represents the number of channels of the output.

In some embodiments, the NN-based model may comprise a grouped convolution layer. A sample of an output tensor of the grouped convolution layer may be determined based on K channels of an input tensor of the grouped convolution layer, and K may be dependent on the number of channels of the input tensor and the number of groups. For example, K may be obtained based on a result of dividing the number of channels of the input tensor by the number of groups. The number of groups may be larger than 1. In one example embodiments, the sample of the output tensor of the grouped convolution layer may be determined only based on samples of the K channels.

By way of example rather than limitation, t an output tensor of the grouped convolution layer may be determined as follows:

$$out [ {c}_{o u t} , i , j ] = bias [ {c}_{o u t} ] + {\sum }_{{g}^{′} = 0}^{{c}_{i n} / G - 1} weight [ {g}^{′} , {c}_{o u t} ] ⋆ inp [ g \cdot {C}_{i n} / G + {g}^{′} , s \cdot i , s \cdot j ]$$

where g=0, . . . , G−1, and cₒᵤₜ=g·Cₒᵤₜ/G, . . . , (g+1)·Cₒᵤₜ/G−1, and out[ ] represents the output tensor of the grouped convolution layer, bias[ ] represents a bias tensor, weight[ ] represents a weight tensor, inp[ ] represents the input tensor of the grouped convolution layer, Cᵢₙ represents the number of channels of the input tensor, G represents the number of groups, Cout represents the number of channels of the output tensor, “*” represents a convolution operation, “/” represents an integer division operation.

In some embodiments, the NN-based model may comprise a upsampling layer. In one example embodiment, a current sample in the output of the upsampling layer may be determined based on a neighbor sample of the current sample. The neighbor sample may comprise a top-right neighbor sample, a top-left neighbor sample, a bottom-right neighbor sample, a bottom-left neighbor sample, or the nearest neighbor sample in a quarter region. For example, the current sample may be set equal to the neighbor sample. Alternatively, the current sample may be initialized based on the neighbor sample.

In some embodiments, the upsampling layer may be configured to be applied based on a plurality of upsampling ratios. For example, one of the plurality of upsampling ratios may correspond to a vertical direction, and a further one of the plurality of upsampling ratios may correspond to a horizontal direction.

In addition, the plurality of upsampling ratios may be indicated in the bitstream.

In some embodiments, the upsampling layer may be configured to be applied based on a division operation or an integer division operation of an index of a sample. For example, the index may indicate a horizontal coordinate (e.g., a width index) or a vertical coordinate (e.g., a height index) of the sample.

By way of example rather than limitation, an output of the upsampling layer may be determined as follows:

$$output\_u [ c , i , j ] = input\_u [ c , i / s1\_u , j / s2\_u ] ,$$

where i=0, . . . , hₒᵤₜ−1; j=0, . . . , wₒᵤₜ−1; c=0, . . . , C−1, and output_u[ ] represents the output of the upsampling layer, input_u[ ] represents an input of the upsampling layer, s1_u represents a first upsampling ratio, s2_u represents a second upsampling ratio, hₒᵤₜ represents a height of the output, wₒᵤₜ represents a width of the output, C represents the number of channels of the output.

In some embodiments, the NN-based model may comprise a shuffle layer configured to be applied based on a modulo operation. For example, samples of an input tensor of the shuffle layer are reordered in the shuffler layer. By way of example rather than limitation, an output tensor of the shuffle layer may be determined as follows:

$$output\_s [ c , i , j ] = input\_s ( c \cdot ss 1 \cdot ss 2 + ( i \% ss 1 ) \cdot ss 2 + j \% ss 2 , i / ss 1 , j / ss 2 ]$$

where i=0, . . . , hₒᵤₜt−1; j=0, . . . , wₒᵤₜ−1; c=0, . . . , C−1, and output_s[ ] represents the output tensor of the shuffle layer, input_s[ ] represents an input tensor of the shuffle layer, each of ss1 and ss2 represents a scale factor, hₒᵤₜ represents a height of the output tensor, wₒᵤₜ represents a width of the output tensor, C represents the number of channels of the output tensor, and “%” represents the modulo operation.

In view of the above, the solutions in accordance with some embodiments of the present disclosure can at least solve the problems mentioned in above section 4. Thereby, the coding efficiency and coding quality can be improved.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: performing a conversion between the visual data and the bitstream with a neural network (NN)-based model, a pooling layer in the NN-based model being configured to be applied with a padding operation that is used for padding at least one sample for an input tensor of the pooling layer.

According to still further embodiments of the present disclosure, a method for storing bitstream of visual data is provided. The method comprises: performing a conversion between the visual data and the bitstream with a neural network (NN)-based model, a pooling layer in the NN-based model being configured to be applied with a padding operation that is used for padding at least one sample for an input tensor of the pooling layer; and storing the bitstream in a non-transitory computer-readable recording medium.

Implementations of the present disclosure can be described in view of the following clauses, the features of which can be combined in any reasonable manner.

Clause 1. A method for visual data processing, comprising: performing a conversion between visual data and a bitstream of the visual data with a neural network (NN)-based model, a pooling layer in the NN-based model being configured to be applied with a padding operation that is used for padding at least one sample for an input tensor of the pooling layer.

Clause 2. The method of clause 1, wherein all of the at least one sample are padded with a same padding value.

Clause 3. The method of clause 2, wherein the padding value is represented by M.

Clause 4. The method of any of clauses 2-3, wherein the padding value is not equal to 0.

Clause 5. The method of any of clauses 1-4, wherein the number of the at least one sample is dependent on a size of the input tensor and a kernel size of the pooling layer.

Clause 6. The method of any of clauses 1-5, wherein the at least one sample comprises one or more of the following: a sample at a right boundary of the input tensor, or a sample at a bottom boundary of the input tensor.

Clause 7. The method of any of clauses 1-6, wherein the padding operation is performed as follows:
if i≥hᵢₙ or j≥wᵢₙ, input[c, i, j] is set to be equal to M,
wherein input[ ] represents the input tensor of the pooling layer, c represents a channel index of a sample, i represents a height index of the sample, j represents a width index of the sample, M represents a padding value, hᵢₙ represents a height of the input tensor, and wᵢₙ represents a width of the input tensor.

Clause 8. The method of any of clauses 1-7, wherein the pooling layer comprises an average pooling layer, and the average pooling layer is configured to be applied with a bit-shift operation.

Clause 9. The method of clause 8, wherein a bit-shift amount of the bit-shift operation is dependent on a kernel size of the average pooling layer.

Clause 10. The method of clause 9, wherein the bit-shift amount is equal to 2×log 2(k), and k represents the kernel size.

Clause 11. The method of any of clauses 9-10, wherein the kernel size is equal to 8, and the bit-shift amount is equal to 6.

Clause 12. The method of any of clauses 1-11, wherein a current sample of an output of the pooling layer is determined by: determining a sum of a plurality of samples associated with the input tensor, wherein if the plurality of samples comprise one or more samples outside the input tensor, the one or more samples are padded with the padding operation; obtaining an intermediate result by adding an offset value to the sum; and applying a bit-shift operation on the intermediate result to obtain the current sample.

Clause 13. The method of clause 12, wherein at least one of the following is dependent on a kernel size of the pooling layer: the number of the plurality of samples, the offset value, or a bit-shift amount of the bit-shift operation.

Clause 14. The method of any of clauses 1-13, wherein an output tensor of the pooling layer is determined as follows:

$$output [ c , i , j ] = ( \frac{{k}^{2}}{2} + {\sum }_{m = 0}^{k - 1} {\sum }_{n = 0}^{k - 1} input [ c , i * k + m , j * k + n ] ) ≫ ( 2 * log 2 ( k ) ) ,$$

wherein i=0, . . . , hₒᵤₜ−1; j=0, . . . , wₒᵤₜ−1; c=0, . . . , C−1, and if i*k+m≥hᵢₙ or j*k+n≥wᵢₙ, input[c, i*k+m, j*k+n] is set to be equal to M, and
wherein output[ ] represents the output tensor, k represents a kernel size of the pooling layer, input[ ] represents the input tensor of the pooling layer, hₒᵤₜ represents a height of the output tensor, wₒᵤₜ represents a width of the output tensor, C represents the number of channels of the output tensor, hᵢₙ represents a height of the input tensor, wᵢₙ represents a width of the input tensor, and M represents a padding value.

Clause 15. The method of any of clauses 1-14, wherein a size of an output tensor of the pooling layer is determined as follows:

$${h}_{o u t} = ( {h}_{i n} + k - 1 ) ≫ log 2 ( k ) , {w}_{o u t} = ( {w}_{i n} + k - 1 ) ≫ log 2 ( k ) ,$$

wherein hₒᵤₜ represents a height of the output tensor, wₒᵤₜ represents a width of the output tensor, hᵢₙ represents a height of the input tensor, wᵢₙ represents a width of the input tensor, and k represents a kernel size of the pooling layer.

Clause 16. The method of any of clauses 1-15, wherein the kernel size k is equal to 8.

Clause 17. The method of any of clauses 1-16, wherein the NN-based model comprises a downsampling layer, and an output of the downsampling layer is determined as follows:

$$output\_d [ c , i , j ] = input\_d [ c , s 1 \_d \cdot i , s2\_d \cdot j ] ,$$

wherein i=0, . . . , hₒᵤₜ−1; j=0, . . . , wₒᵤₜ−1; c=0, . . . , C−1, and
wherein output_d[ ] represents the output of the downsampling layer, input_d[ ] represents an input of the downsampling layer, s1_d represents a first downsampling ratio, s2_d represents a second downsampling ratio, hₒᵤₜ represents a height of the output, wₒᵤₜ represents a width of the output, C represents the number of channels of the output.

Clause 18. The method of any of clauses 1-17, wherein the NN-based model comprises a grouped convolution layer, and an output tensor of the grouped convolution layer is determined as follows:

$$out [ {c}_{o u t} , i , j ] = bias [ {c}_{o u t} ] + {\sum }_{{g}^{′} = 0}^{{C}_{i n} / G - 1} weight [ {g}^{′} , {c}_{o u t} ] ⋆ inp [ g \cdot {C}_{i n} / G + {g}^{′} , s \cdot i , s \cdot j ]$$

wherein g=0, . . . , G−1, and cₒᵤₜ=g·Cₒᵤₜ/G, . . . , (g+1)·Cₒᵤₜ/G−1, and
wherein out[ ] represents the output tensor of the grouped convolution layer, bias[ ] represents a bias tensor, weight[ ] represents a weight tensor, inp[ ] represents the input tensor of the grouped convolution layer, Cᵢₙ represents the number of channels of the input tensor, G represents the number of groups, Cₒᵤₜ represents the number of channels of the output tensor, “*” represents a convolution operation, “/” represents an integer division operation.

Clause 19. The method of any of clauses 1-18, wherein the NN-based model comprises a upsampling layer.

Clause 20. The method of clause 19, wherein a current sample in the output of the upsampling layer is determined based on a neighbor sample of the current sample.

Clause 21. The method of clause 20, wherein the neighbor sample comprises one of the following: a top-right neighbor sample, a top-left neighbor sample, a bottom-right neighbor sample, a bottom-left neighbor sample, or the nearest neighbor sample in a quarter region.

Clause 22. The method of any of clauses 20-21, wherein the current sample is set equal to the neighbor sample, or the current sample is initialized based on the neighbor sample.

Clause 23. The method of any of clauses 19-22, wherein the upsampling layer is configured to be applied based on a plurality of upsampling ratios.

Clause 24. The method of clause 23, wherein one of the plurality of upsampling ratios corresponds to a vertical direction, and a further one of the plurality of upsampling ratios corresponds to a horizontal direction.

Clause 25. The method of clause 24, wherein the plurality of upsampling ratios are indicated in the bitstream.

Clause 26. The method of any of clauses 19-25, wherein the upsampling layer is configured to be applied based on a division operation or an integer division operation of an index of a sample.

Clause 27. The method of any of clauses 19-26, wherein an output of the upsampling layer is determined as follows:

$$output\_u [ c , i , j ] = input\_u [ c , i / s 1 \_u , j / s2\_u ] ,$$

wherein i=0, . . . , hₒᵤₜ−1; j=0, . . . , wₒᵤₜ−1; c=0, . . . , C−1, and
wherein output u[ ] represents the output of the upsampling layer, input u[ ] represents an input of the upsampling layer, s1_u represents a first upsampling ratio, s2_u represents a second upsampling ratio, hₒᵤₜ represents a height of the output, wₒᵤₜ represents a width of the output, C represents the number of channels of the output.

Clause 28. The method of any of clauses 1-27, wherein the NN-based model comprises a downsampling layer configured to be applied based on a multiplication operation of an index of a sample.

Clause 29. The method of clause 26 or 28, wherein the index indicates a horizontal coordinate or a vertical coordinate of the sample.

Clause 30. The method of any of clauses 28-29, wherein a size of an input of the downsampling layer and a size of an output of the downsampling layer have the following relationship:

$${h}_{i n} = s1\_d \cdot {h}_{o u t} + n , {w}_{i n} = s2\_d \cdot {w}_{o u t} + m ,$$

wherein hᵢₙ represents a height of the input, wᵢₙ represents a width of the input, hₒᵤₜ represents a height of the output, wₒᵤₜ represents a width of the output, each of s1_d and s2_d represents a downsampling ratio of the downsampling layer, and each of n and m is a non-negative integer.

Clause 31. The method of any of clauses 1-30, wherein the NN-based model comprises a grouped convolution layer, and a sample of an output tensor of the grouped convolution layer is determined based on K channels of an input tensor of the grouped convolution layer, and K is dependent on the number of channels of the input tensor and the number of groups.

Clause 32. The method of clause 31, wherein K is obtained based on a result of dividing the number of channels of the input tensor by the number of groups.

Clause 33. The method of any of clauses 31-32, wherein the number of groups is larger than 1.

Clause 34. The method of any of clauses 31-33, wherein the sample of the output tensor of the grouped convolution layer is determined only based on samples of the K channels.

Clause 35. The method of any of clauses 1-26, wherein the NN-based model comprises a shuffle layer configured to be applied based on a modulo operation.

Clause 36. The method of clause 35, wherein samples of an input tensor of the shuffle layer are reordered in the shuffler layer.

Clause 37. The method of any of clauses 35-36, wherein an output tensor of the shuffle layer is determined as follows:

$$output\_s [ c , i , j ] = input\_s [ c \cdot ss 1 \cdot ss 2 + ( i \% ss 1 ) \cdot ss 2 + j \% ss 2 , i / ss 1 , j / ss 2 ]$$

wherein i=0, . . . , hₒᵤₜ−1; j=0, . . . , wₒᵤₜ−1; c=0, . . . , C−1, and
wherein output_s[ ] represents the output tensor of the shuffle layer, input_s[ ] represents an input tensor of the shuffle layer, each of ss1 and ss2 represents a scale factor, hₒᵤₜ represents a height of the output tensor, wₒᵤₜ represents a width of the output tensor, C represents the number of channels of the output tensor, and “%” represents the modulo operation.

Clause 38. The method of any of clauses 1-7, wherein the pooling layer comprises a max pooling layer, and an output tensor of the max pooling layer is determined as follows:

$$output [ c , i , j ] = {max}_{m = 0 , … , k - 1} {max}_{n = 0 , … , k - 1} input [ c , i + m , j + n ]$$

wherein i=0, . . . , hₒᵤₜ−1; j=0, . . . , wₒᵤₜ−1; c=0, . . . , C−1, and if i*k+m≥hᵢₙ or j*k+n≥wᵢₙ, input[c, i+m, j+n] is set to be equal to M, and
wherein output[ ] represents the output tensor, k represents a kernel size of the pooling layer, input[ ] represents the input tensor of the max pooling layer, hₒᵤₜ represents a height of the output tensor, wout represents a width of the output tensor, C represents the number of channels of the output tensor, hᵢn represents a height of the input tensor, wᵢₙ represents a width of the input tensor, and M represents a padding value.

Clause 39. The method of any of clauses 1-7, wherein the pooling layer comprises a min pooling layer, and an output tensor of the min pooling layer is determined as follows:

$$output [ c , i , j ] = {max}_{m = 0 , … , k - 1} {max}_{n = 0 , … , k - 1} input [ c , i + m , j + n ] ,$$

wherein i=0, . . . , hₒᵤₜ−1; j=0, . . . , wₒᵤₜ−1; c=0, . . . , C−1, and if i*k+m≥hᵢₙ or j*k+n≥wᵢₙ, input[c, i+m, j+n] is set to be equal to M, and
wherein output[ ] represents the output tensor, k represents a kernel size of the pooling layer, input[ ] represents the input tensor of the min pooling layer, hₒᵤₜ represents a height of the output tensor, wₒᵤₜ represents a width of the output tensor, C represents the number of channels of the output tensor, hᵢₙ represents a height of the input tensor, wᵢₙ represents a width of the input tensor, and M represents a padding value.

Clause 40. The method of any of clauses 1-39, wherein the visual data comprise a video, a picture of the video, or an image.

Clause 41. The method of any of clauses 1-40, wherein the conversion includes encoding the visual data into the bitstream.

Clause 42. The method of any of clauses 1-40, wherein the conversion includes decoding the visual data from the bitstream.

Clause 43. An apparatus for visual data processing comprising a processor and a non-transitory memory with instructions thereon, wherein the instructions upon execution by the processor, cause the processor to perform a method in accordance with any of clauses 1-42.

Clause 44. A non-transitory computer-readable storage medium storing instructions that cause a processor to perform a method in accordance with any of clauses 1-42.

Clause 45. A non-transitory computer-readable recording medium storing a bitstream of visual data which is generated by a method performed by an apparatus for visual data processing, wherein the method comprises: performing a conversion between the visual data and the bitstream with a neural network (NN)-based model, a pooling layer in the NN-based model being configured to be applied with a padding operation that is used for padding at least one sample for an input tensor of the pooling layer.

Clause 46. A method for storing a bitstream of visual data, comprising: performing a conversion between the visual data and the bitstream with a neural network (NN)-based model, a pooling layer in the NN-based model being configured to be applied with a padding operation that is used for padding at least one sample for an input tensor of the pooling layer; and storing the bitstream in a non-transitory computer-readable recording medium.

### Example Device

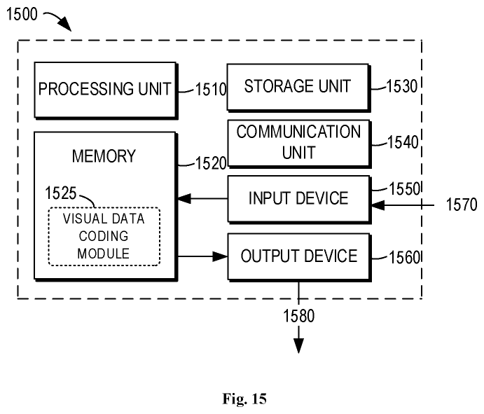

FIG. 15 illustrates a block diagram of a computing device 1500 in which various embodiments of the present disclosure can be implemented. The computing device 1500 may be implemented as or included in the source device 110 (or the visual data encoder 114) or the destination device 120 (or the visual data decoder 124).

It would be appreciated that the computing device 1500 shown in FIG. 15 is merely for purpose of illustration, without suggesting any limitation to the functions and scopes of the embodiments of the present disclosure in any manner.

As shown in FIG. 15, the computing device 1500 includes a general-purpose computing device 1500. The computing device 1500 may at least comprise one or more processors or processing units 1510, a memory 1520, a storage unit 1530, one or more communication units 1540, one or more input devices 1550, and one or more output devices 1560.

In some embodiments, the computing device 1500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1500 can support any type of interface to a user (such as “wearable” circuitry and the like).

The processing unit 1510 may be a physical or virtual processor and can implement various processes based on programs stored in the memory 1520. In a multi-processor system, multiple processing units execute computer executable instructions in parallel so as to improve the parallel processing capability of the computing device 1500. The processing unit 1510 may also be referred to as a central processing unit (CPU), a microprocessor, a controller or a microcontroller.

The computing device 1500 typically includes various computer storage medium. Such medium can be any medium accessible by the computing device 1500, including, but not limited to, volatile and non-volatile medium, or detachable and non-detachable medium. The memory 1520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1530 may be any detachable or non-detachable medium and may include a machine-readable medium such as a memory, flash memory drive, magnetic disk or another other media, which can be used for storing information and/or visual data and can be accessed in the computing device 1500.

The computing device 1500 may further include additional detachable/non-detachable, volatile/non-volatile memory medium. Although not shown in FIG. 15, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1540 communicates with a further computing device via the communication medium. In addition, the functions of the components in the computing device 1500 can be implemented by a single computing cluster or multiple computing machines that can communicate via communication connections. Therefore, the computing device 1500 can operate in a networked environment using a logical connection with one or more other servers, networked personal computers (PCs) or further general network nodes.

The input device 1550 may be one or more of a variety of input devices, such as a mouse, keyboard, tracking ball, voice-input device, and the like. The output device 1560 may be one or more of a variety of output devices, such as a display, loudspeaker, printer, and the like. By means of the communication unit 1540, the computing device 1500 can further communicate with one or more external devices (not shown) such as the storage devices and display device, with one or more devices enabling the user to interact with the computing device 1500, or any devices (such as a network card, a modem and the like) enabling the computing device 1500 to communicate with one or more other computing devices, if required. Such communication can be performed via input/output (I/O) interfaces (not shown).

In some embodiments, instead of being integrated in a single device, some or all components of the computing device 1500 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1500 may be used to implement visual data encoding/decoding in embodiments of the present disclosure. The memory 1520 may include one or more visual data coding modules 1525 having one or more program instructions. These modules are accessible and executable by the processing unit 1510 to perform the functionalities of the various embodiments described herein.

In the example embodiments of performing visual data encoding, the input device 1550 may receive visual data as an input 1570 to be encoded. The visual data may be processed, for example, by the visual data coding module 1525, to generate an encoded bitstream. The encoded bitstream may be provided via the output device 1560 as an output 1580.

In the example embodiments of performing visual data decoding, the input device 1550 may receive an encoded bitstream as the input 1570. The encoded bitstream may be processed, for example, by the visual data coding module 1525, to generate decoded visual data. The decoded visual data may be provided via the output device 1560 as the output 1580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for visual data processing, comprising:
performing a conversion between visual data and a bitstream of the visual data with a neural network (NN)-based model, a pooling layer in the NN-based model being configured to be applied with a padding operation that is used for padding at least one sample for an input tensor of the pooling layer.

2. The method of claim 1, wherein all of the at least one sample are padded with a same padding value, or
wherein the number of the at least one sample is dependent on a size of the input tensor and a kernel size of the pooling layer, or
wherein the at least one sample comprises one or more of the following: a sample at a right boundary of the input tensor, or a sample at a bottom boundary of the input tensor.

3. The method of claim 2, wherein the padding value is represented by M, or
wherein the padding value is not equal to 0.

4. The method of claim 1, wherein the padding operation is performed as follows:
if i≥hᵢₙ or j≥wᵢₙ, input[c, i, j] is set to be equal to M,
wherein input[ ] represents the input tensor of the pooling layer, c represents a channel index of a sample, i represents a height index of the sample, j represents a width index of the sample, M represents a padding value, hᵢₙ represents a height of the input tensor, and wᵢₙ represents a width of the input tensor.

5. The method of claim 1, wherein the pooling layer comprises an average pooling layer, and the average pooling layer is configured to be applied with a bit-shift operation.

6. The method of claim 5, wherein a bit-shift amount of the bit-shift operation is dependent on a kernel size of the average pooling layer.

7. The method of claim 6, wherein the bit-shift amount is equal to 2×log 2(k), and k represents the kernel size, or
wherein the kernel size is equal to 8, and the bit-shift amount is equal to 6.

8. The method of claim 1, wherein a current sample of an output of the pooling layer is determined by:
determining a sum of a plurality of samples associated with the input tensor, wherein if the plurality of samples comprise one or more samples outside the input tensor, the one or more samples are padded with the padding operation;
obtaining an intermediate result by adding an offset value to the sum; and
applying a bit-shift operation on the intermediate result to obtain the current sample.

9. The method of claim 8, wherein at least one of the following is dependent on a kernel size of the pooling layer:
the number of the plurality of samples,
the offset value, or
a bit-shift amount of the bit-shift operation.

10. The method of claim 1, wherein an output tensor of the pooling layer is determined as follows:
$$output [ c , i , j ] = ( \frac{{k}^{2}}{2} + {\sum }_{m = 0}^{k - 1} {\sum }_{n = 0}^{k - 1} input [ c , i * k + m , j * k + n ] ) ≫ ( 2 * log 2 ( k ) ) ,$$
wherein i=0, . . . , hₒᵤₜ−1; j=0, . . . , wₒᵤₜ−1; c=0, . . . , C−1, and if i*k+m≥hᵢₙ or j*k+n≥wᵢₙ, input[c, i*k+m, j*k+n] is set to be equal to M, and
wherein output[ ] represents the output tensor, k represents a kernel size of the pooling layer, input[ ] represents the input tensor of the pooling layer, hₒᵤₜ represents a height of the output tensor, wₒᵤₜ represents a width of the output tensor, C represents the number of channels of the output tensor, hᵢₙ represents a height of the input tensor, wᵢₙ represents a width of the input tensor, and M represents a padding value.

11. The method of claim 1, wherein a size of an output tensor of the pooling layer is determined as follows:
$${h}_{o u t} = ( {h}_{i n} + k - 1 ) ≫ log 2 ( k ) , {w}_{o u t} = ( {w}_{i n} + k - 1 ) ≫ log 2 ( k ) ,$$
wherein hₒᵤₜ represents a height of the output tensor, wₒᵤₜ represents a width of the output tensor, hᵢₙ represents a height of the input tensor, wᵢₙ represents a width of the input tensor, and k represents a kernel size of the pooling layer.

12. The method of claim 1, wherein the kernel size k is equal to 8.

13. The method of claim 1, wherein the NN-based model comprises a downsampling layer, and an output of the downsampling layer is determined as follows:
$$output\_d [ c , i , j ] = input\_d [ c , s 1 \_d \cdot i , s2\_d \cdot j ] ,$$
wherein i=0, . . . , hₒᵤₜ−1; j=0, . . . , wₒᵤₜ−1; c=0, . . . , C−1, and
wherein output_d[ ] represents the output of the downsampling layer, input d[ ] represents an input of the downsampling layer, s1_d represents a first downsampling ratio, s2_d represents a second downsampling ratio, hₒᵤₜ represents a height of the output, wₒᵤₜ represents a width of the output, C represents the number of channels of the output.

14. The method of claim 1, wherein the NN-based model comprises a grouped convolution layer, and an output tensor of the grouped convolution layer is determined as follows:
$$out [ {c}_{o u t} , i , j ] = bias [ {c}_{o u t} ] + {\sum }_{{g}^{{}_{′}} = 0}^{{C}_{i n} / G - 1} weight [ {g}^{′} , {c}_{o u t} ] ⋆ inp [ g \cdot {C}_{i n} / G + {g}^{′} , s \cdot i , s \cdot j ]$$
wherein g=0, . . . , G−1, and cₒᵤₜ=g·Cₒᵤₜ/G, . . . , (g+1)·Cₒᵤₜ/G−1, and
wherein out[ ] represents the output tensor of the grouped convolution layer, bias[ ] represents a bias tensor, weight[ ] represents a weight tensor, inp[ ] represents the input tensor of the grouped convolution layer, Cᵢₙ represents the number of channels of the input tensor, G represents the number of groups, Cₒᵤₜ represents the number of channels of the output tensor, “*” represents a convolution operation, “/” represents an integer division operation.

15. The method of claim 1, wherein the visual data comprise a video, a picture of the video, or an image.

16. The method of claim 1, wherein the conversion includes encoding the visual data into the bitstream.

17. The method of claim 1, wherein the conversion includes decoding the visual data from the bitstream.

18. The method of claim 1, wherein the conversion comprises: generating the bitstream from the visual data, and
the method further comprises: storing the bitstream in a non-transitory computer-readable recording medium.

19. An apparatus for visual data processing comprising a processor and a non-transitory memory with instructions thereon, wherein the instructions upon execution by the processor, cause the processor to perform operations comprising:
performing a conversion between visual data and a bitstream of the visual data with a neural network (NN)-based model, a pooling layer in the NN-based model being configured to be applied with a padding operation that is used for padding at least one sample for an input tensor of the pooling layer.

20. A non-transitory computer-readable storage medium storing instructions that cause a processor to perform operations comprising:
performing a conversion between visual data and a bitstream of the visual data with a neural network (NN)-based model, a pooling layer in the NN-based model being configured to be applied with a padding operation that is used for padding at least one sample for an input tensor of the pooling layer.
